(19) United States
(12) Patent Application Publication
(10) Pub. No.: US 2016/0353149 A1
(43) Pub. Date: Dec. 1, 2016

(54) A RECORDED BROADCAST OF A SERIES OF SHORT VIDEOS

(71) Applicant: SAFETONET LIMITED, Reading (GB)

(72) Inventor: Richard Pursey, London (GB)

(21) Appl. No.: 15/116,310

(22) PCT Filed: Feb. 3, 2015
(86) PCT No.: PCT/EP2015/052195

§ 371 Date: Aug. 3, 2016

(30) Foreign Application Priority Data
Feb. 3, 2014 (GB) 1401766.9
Jul. 11, 2014 (GB) 1412364.0

(51) Int. Cl. H04N 21/2743; H04N 21/262; H04N 21/8549; H04N 21/2668; H04N 21/433; H04N 21/845; H04N 21/234; H04N 21/2665

(52) U.S. Cl. CPC H04N 21/2743; H04N 21/23424; H04N 21/26258; H04N 21/2665; H04N 21/2668; H04N 21/4334; H04N 21/8456; H04N 21/8549

(57) ABSTRACT

This invention relates to a means for creating and broadcasting a film wherein the film comprises a first transmitted originating video broadcast and a subsequent transmitted one or more video broadcasts appended thereto.

### TECHNICAL FIELD

This invention relates generally to the transmission of a recorded broadcast by an electronic device to single or multiple viewers. More particularly this invention relates to the capture and transmission of a recorded video broadcast which is then appended to connected broadcasts recorded by others on differing devices in differing places and at differing times. The appended broadcasts then make a film which can then be edited, if required, and then viewed.

### BACKGROUND TO THE INVENTION

Current methods of transmission of recorded video broadcasts on multiple electronic devices do not allow for each broadcast to be appended to the other in time sequenced format and to then be viewed simultaneously by single or multiple users in a single film. The invention provides a simple but effective method of creating a sequence of timed videos recorded by different people in different places and where the originator of the first broadcast selects which users are automatically included within (are permitted to view) the sequenced broadcast and which users can then edit and re-sequence the collection of subsequent recorded broadcasts.

### SUMMARY OF THE INVENTION

The present invention provides a video system as defined in the claims.

An embodiment of the invention to be described enables the creation of multiple recorded video (e.g. moving images and sound) broadcasts for transmission on an electronic device and which follow on from the first (originating broadcast) or most recent broadcast (subsequent broadcast) recorded on one individual device.

Each recorded broadcast may be transmitted from multiple different devices at different times and in different places. The embodiment includes a broadcast record manager to record and time-stamp the broadcast, an audience manager to select the number of viewers or selected viewers, a broadcast transmission manager to transmit the recorded broadcast, a distribution network manager to select the destination or location for the display of the recorded broadcast, a broadcast redo and preview manager that enables a preview and redo of the recorded broadcast on an electronic device prior to transmission, an appending broadcast manager to time sequence and append the latest broadcast to the most recently recorded and transmitted broadcast, a broadcast notification manager notifying the viewer of the recorded broadcast, an editing broadcasting manager that allows the original broadcaster to edit and delete individual broadcasts in the appended film or a contributing member of the broadcast to delete their own contributing recording and the entire collection of appended and edited broadcasts to be re-broadcast.

### BRIEF DESCRIPTION OF THE DRAWINGS

For a better understanding of the present invention an embodiment will now be described by way of example, with reference to the accompanying drawings, in which:

FIG. 1 is a flow chart that illustrates the operation of the embodiment

FIG. 2 shows and example system architecture to illustrate the operation of the embodiment

### DETAILED DESCRIPTION OF EMBODIMENT OF THE INVENTION

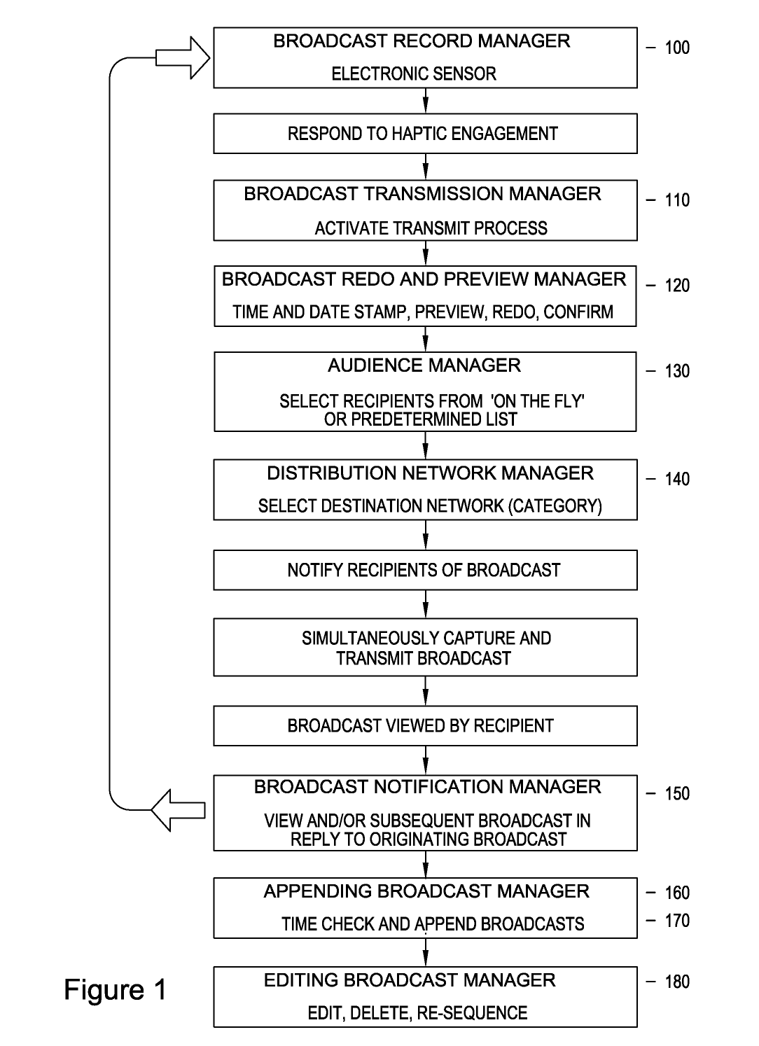

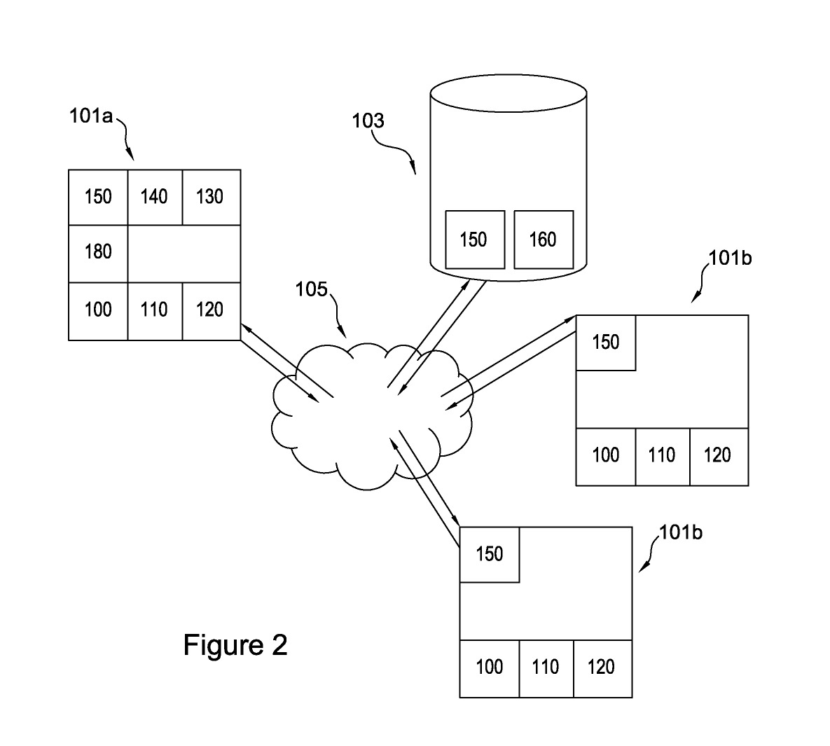

FIGS. 1 and 2 provide details of the operation of the embodiment on a electronic devices 101a and 101b, and server 103, which are connected by the Internet 105. The electronic device 101a and 101b may include but are not restricted to: a desk top computer, PC, tablet or smartphone, smartwatch device with the following features: a (e.g. wireless) processor and memory. The device 101a may be an originator (or controlling contributor) device, and devices 101b may be secondary contributor devices.

A Broadcast Record Manager 100 (e.g. provided on the device 101a and on the devices 101b) activates the recording and storage of the originating broadcast on an electronic device 101a. The Broadcast Record Manager may automatically restrict (or select) the recording time of a recording. The originating recorded broadcast is captured by digital sensors within the electronic device 101a through a process of the art. The Broadcast Record Manager is operated by haptic or other engagement of a digital sensor controller on an electronic device 101a.

A Broadcast Transmission Manager 110 (e.g. provided on the device 101a and on the devices 101b) is controlled by a digital sensor control pad that responds to haptic or other engagement that activates the process to transmit a recorded broadcast on an electronic device 101a/101b.

A Broadcast Redo and Preview Manager 120 (e.g. provided on the device 101a and on the devices 101b) enables a preview of the originating (and subsequent) recorded broadcast and redo of the recorded broadcast on an electronic device prior to transmission. Upon transmission the originating recorded broadcast is time and date stamped.

An Audience Manager 130 (e.g. provided on the device 101a) selects the desired viewers 101b for the originating recorded broadcast on an electronic device 101a. The Audience Manager allows the broadcaster to select the number of viewers from one up to several million either individually or by defined groups or listings or by selecting everyone listed in the broadcaster's contacts list.

A Distribution Network Manager 140 (e.g. provided on the device 101a) selects the destination or location for the display of the originating recorded broadcast on an electronic device 101a. The Distribution Network Manager is operated by haptic or other engagement of the digital sensor controller. The Distribution Network Manager is a video data filing system that categorizes the originating recorded broadcast by type or genre and facilitate the viewing of the broadcast with the relevant subject matter index on the electronic devices 101a/101b.

A Broadcast Notification Manager 150 (e.g. provided on the device 101a, on the devices 101b and on the server 103) notifies the viewer of the originating (and subsequent) recorded broadcast upon transmission. The Broadcast Notification Manager achieves this by automatically identifying the status and progress of an uploaded message by communication back to the server 103 to query a database as to when the content is available for viewing. The Broadcast Notification Manager automatically updates all users on the database that are attached to the broadcast (e.g., the users selected by the broadcaster) by sending them a notification that the content is available for viewing. The Broadcast Notification Manager is operated by haptic or other engagement of the digital sensor controller which allows the viewer to then reply to the incoming broadcast with a subsequent recorded broadcast which instigates a repeat of the above process as many times as viewers wish to record subsequent broadcasts.

An Appending Broadcast Manager 160 (e.g. provided on the device 101a and on the server 103) time checks each subsequent recorded broadcast. An automated video caching organiser identifies the users to confirm whether or not the user can contribute to the broadcast and automatically co-ordinates and renders each subsequent recorded broadcast to the most recently subsequent recorded broadcast so as to create a connected reel of time sequenced subsequent recorded broadcasts that are in reply to the originating recorded broadcast and other subsequent recorded broadcasts 170. The initially selected viewers can then watch the originating recorded broadcast that has been rendered in time sequence to the subsequent recorded broadcasts.

An Editing Broadcast Manager 180 (e.g. provided on the device 101a) allows the recorder of the originating recorded broadcast to then delete on choice individual subsequent recorded broadcasts from the reel, place them in a new order or edit and add sub-titles or effects to each subsequent recorded broadcast. The Editing Broadcast Manager also allows a contributing user of the broadcast to delete their own content.

Computer and media source code has been created or utilized for the purposes of this invention, or such code has been utilized that may be of the type that is available to those having the skill or expertise in the field of computer software. Examples of computer-readable media include, but are not limited to: magnetic media such as hard discs, floppy discs, and magnetic tape; optical media such as CD-ROMs, DVDs and holographic devices; magneto-optical media; and hardware devices that are specially configured to store administer and execute program code, as applicable to the field of computer software such as programmable logic devices, application specific integrated circuits, read only memory and random access memory. The invention is or may be implemented by use of a variety of computer code including but not restricted to; JAVA, C++ and other programming syntax, language or development code.

1. A video system operable to concatenate respective video portions from an originating contributor and at least one secondary contributor, the system including control means for use by the originating contributor and operable control concatenation of the or each video portion from the originating contributor and the or each video portion from the or each secondary contributor.

2. The system of claim 1, wherein the control means includes distributing means for distributing the concatenated video portions as a single item of video content.

3. The system of claim 1, wherein the control means is operable to receive and interpret time and/or date information relating to the video portions and to perform the concatenation in dependence thereon.

4. The system of claim 1, including preview means operable to enable the originating contributor to preview and edit the concatenated video portions.

5. The system of claim 1, including a video categoriser operable to associate attributes relating to the subject matter of the concatenated video portions with the concatenated video portions.

6. The system of claim 5, including a distribution manager operable to control distribution of the concatenated video portions in dependence on the associated attributes.

7. The system of claim 1, including an audience manager operable to enable the originating contributor to select users permitted to consume the concatenated video portions.

8. The system of claim 7, wherein the audience manager enables the originating contributor to select users permitted to consume the concatenated video portions in dependence upon the identity of the or each secondary contributor.

9. The system of claim 7, including a notification manager operable to notify the selected users of the availability of the concatenated portions.

10. The system of claim 1, including video manager operable to enable the originating contributor to edit the concatenated video portions or individual ones of the video portions, or to reorder the video portions in the concatenated sequence.

11. The system of claim 10, wherein the video manager is operable to enable the or each secondary contributor to edit the video portion from the or each secondary contributor.

12. The system of claim 1, wherein the video portions are recorded by the same or different recording devices at differing places and/or times.
